(19) United States
(12) Patent Application Publication
(10) Pub. No.: US 2026/0224047 A1
(43) Pub. Date: Aug. 6, 2026

(54) OPEN FRONTED FOOD STORAGE CABINET

(71) Applicant: THE ALAN NUTTALL PARTNERSHIP LIMITED, Hinckley (GB)

(72) Inventor: Michael Steele, Hinckley (GB)

(21) Appl. No.: 19/150,484

(22) PCT Filed: Jan. 23, 2024
(86) PCT No.: PCT/GB2024/050181

§ 371 Date: Jul. 23, 2025

(30) Foreign Application Priority Data
Jan. 24, 2023 (GB) 2301011.9

(51) Int. Cl. A47F 3/04; A47F 3/00

(52) U.S. Cl. CPC A47F 3/0447; A47F 3/001

(57) ABSTRACT

An open fronted food storage cabinet comprising: a top, rear, base and opposed sides, the top, rear, base and opposing sides defining an interior space of the cabinet which is accessible through an opening to the front of the cabinet defined between edges of the top, base and opposing sides of the cabinet; a camera configured to capture an image of the interior space and output a signal; and a display communicatively coupled to the camera, the display configured to receive the signal and show the image.

### FIELD OF THE INVENTION

The present invention relates to an open fronted food storage cabinet.

### BACKGROUND OF THE INVENTION

Open fronted food display cabinets are regularly used in the food retail industry as a convenient means of giving consumers direct access to foods in regulated, typically non-room temperature, conditions. However, such cabinets can often be limited in their functionality, inefficient to run, and inconvenient to monitor/restock.

### SUMMARY OF THE INVENTION

A first aspect of the invention provides an open fronted food storage cabinet comprising: a top, rear, base and opposed sides, the top, rear, base and opposing sides defining an interior space of the cabinet which is accessible through an opening to the front of the cabinet defined between edges of the top, base and opposing sides of the cabinet; a camera configured to capture an image of the interior space and output a signal; and a display communicatively coupled to the camera, the display configured to receive the signal and show the image.

With this arrangement, the contents of the cabinet can more easily be viewed without interrupting the view of a consumer, and without having to be concerned with non-transparent components (e.g. fans, temperature control elements) of the cabinet blocking the view of the retailer. The display may also allow the contents to be viewed more accurately, as possible distortion caused by viewing the contents through angled glass may distort what is viewed.

The camera may be configured to capture a plurality of images, and the display is configured to show a video comprising the plurality of images. This ensures the display of the contents in the cabinet is up-to-date, with any changes being shown more quickly.

The camera may comprise a fisheye lens. A fish-eye lens allows the camera to be positioned closer to the food items within the cabinet, e.g. within the interior space, whilst still allowing all or the majority of the food items to be viewed at once.

The camera may be located within the interior space. This is a convenient position that helps move the camera to a position out of view of a consumer viewing the contents of the cabinet, whilst allowing the camera to view the contents.

The camera may be located towards the front of the cabinet. This can allow the food items at the front of the cabinet to be viewed more easily, which is advantageous as these are the food items that are more readily seen by the consumer and therefore should always be stocked at a minimum where possible.

The camera may be directed towards the rear side of the cabinet. This allows the display to show a front view image of the cabinet contents, as from the view of the consumer. This allows stock levels and display quality to be checked from the perspective of the consumer, rather than from the rear of the cabinet where false positives in regards to stock levels and quality may be encountered.

The display may comprise a display screen. The display may be located adjacent a rear facing panel of the rear side. This provides a convenient place for the display to be placed that doesn't disrupt the view of the consumer, and also negates the need for the retailer to move to the front of the cabinet to check stocks and thereby also block the view of the consumer. Alternatively, the display may be provided at a location that is separate to the location of the cabinet. For example, the cabinet may be provided in a consumer accessible section of a location, and the display may be provided in a staff accessible section of the same location. The staff accessible section of the location may be a food preparation area where food items for the cabinet are prepared. The display can thus provide information and guidance as to when replacement food items need to be prepared so as to restock the cabinet.

Where multiple cabinets containing different food products are provided at a location, then all of the displays may be provided at the staff accessible section of the location so to provide an overview as to the stock levels of all of the cabinets.

In an alternative embodiment the display may be provided at a wholly separate location to the cabinet, for example in a geographically separate location and not in the same building as the cabinet. The cabinet may be provided with a display associated with the cabinet and the ability to send the signal from the camera both to the cabinet display and a remote display provided at a separate location to the camera.

The display may be configured to receive the signal from the camera by either a wired or wireless connection. The wireless connection may be effected by, for example, a BlueTooth connection, a Wireless Internet connection or similar. The camera may be connected to the display via The Cloud.

The display may form part of an assembly including a closure located on a side of the cabinet, the assembly being movable so as to provide access to the interior space. Providing access to the interior space from a side of the cabinet, and using this as the same position for the display, maximises space usage whilst minimising disruption to the view of the consumer that might otherwise be expected if the closure and display were separately placed on the cabinet.

The assembly may be pivotably coupled to the side of the cabinet so as to provide access to the interior space. This provides a convenient way to access the interior space without needing to move the entire assembly.

The assembly may be detachable from the side of the cabinet so as to provide access to the interior space. This allows access to the interior space whilst also allowing the assembly to be moved, for example for repair or replacement.

The assembly may be located on the rear side of the cabinet so as to provide access to the interior space through the rear side. This is typically the most convenient position, as consumers have a generally unobstructed view of the contents from the front unobstructed and the retailer is able to fill the cabinet from the rear.

The assembly may include a fan configured to circulate an airflow through a passageway extending to the front of the cabinet. The assembly may include a temperature control element configured to alter a temperature in a passageway extending to the front of the cabinet.

The multi-use of the assembly for housing the display, fan and/or temperature control element maximises space usage, and minimises disruption to the consumer and retailer. It can also provide a convenient means for more easily accessing the display, fan and/or temperature, particularly when the cassette is removable. For example, a assembly may be replaced in its entirety by a new assembly whilst the old assembly is repaired. This can reduce downtime of the cabinet and increase its operational life.

The assembly may comprise one or more handles for a user to grip the assembly. This provides a means for the user to open, close, or otherwise move the assembly.

The display may be detachable from the assembly. This can provide a convenient means of repairing the display or replacing the display with a new display rapidly so as to minimise disruption to the operation of the cabinet.

The display may be configured to show the image whilst detached from the assembly. With this arrangement, the camera images can be viewed from any suitable location, for example a stock room, kitchen or office. This can be undertaken whilst the assembly is still in place, thereby maintaining the operation of the cabinet whilst negating leave an opening to the interior space where the assembly would have been otherwise.

The top, rear, base and opposed sides may be first top, rear, base and opposed sides, the interior space may be a first interior space of the cabinet, the opening may be a first opening, the camera may be a first camera, and the display may be a first display. The cabinet may comprise a second top, rear, base and opposed sides defining a second interior space of the cabinet which is accessible through a second opening to the front of the cabinet defined between edges of the second top, base and opposing sides of the cabinet; and a second camera configured to capture an image of the second interior space and output a signal; and a second display communicatively coupled to the second camera, the second display configured to receive the signal and show the image.

With this arrangement, a display is provided for each interior space. This allows each display to be better configured for each interior space, and maximises the view within each interior space on the display. Confusion between the interior spaces is also reduced, as each display is associated with a specific interior space rather than multiple interior spaces. This arrangement also assisting in the modularity of the cabinet, as an additional camera and display are provided with each cabinet section.

A second aspect of the invention provides an open fronted food storage cabinet comprising: a top, rear, base and opposed sides, the top, rear, base and opposing sides defining an interior space of the cabinet which is accessible through an opening to the front of the cabinet defined between edges of the top, base and opposing sides of the cabinet; a first passageway extending to the front of the cabinet, and a fan in the first passageway configured to circulate a first airflow through the first passageway and across the front of the cabinet; a second passageway extending to the front of the cabinet, and a fan in the second passageway configured to circulate a second airflow through the second passageway and across the front of the cabinet; wherein the first airflow opposes the second airflow so as to create opposing air curtains across the front of the cabinet.

By providing opposing air curtains, a turbulent meeting point is created across the front of the cabinet. The turbulent airflow accelerates thermal mixing and heat convention, so as to provide a more uniform temperature throughout the interior space. This helps to avoid “dead points” within the interior space that may otherwise be underheated or overheated.

A third aspect of the invention provides an open fronted food storage cabinet comprising: a top, rear, base and opposed sides, the top, rear, base and opposing sides defining an interior space of the cabinet which is accessible through an opening to the front of the cabinet defined between edges of the top, base and opposed sides of the cabinet, wherein a first of the opposed sides define a passageway extending to the front of the cabinet, a fan in the passageway configured to circulate an airflow through the passageway so as to create an air curtain across the front of the cabinet.

By providing a passageway that extends through a side of the cabinet, any passageways on the top and base of the cabinet can be dispensed with. This prevents the top and/or base from being directly heated, and thereby helps to ensure any thermal transfer to the contents of the cabinet (e.g. food items) is by convection, via the airflow, rather than conduction through the base or through the top of an adjacent interior space. Typically, for such open fronted cabinets, the intention is for the contents of the cabinet to be maintained at a given (existing) temperature rather than heated/cooled to a specific temperature. Heat transfer by convection through an airflow all round the food items is preferable for this.

The user (e.g. consumer) of the cabinet is also more likely to touch the base or top of the cabinet when accessing the contents of the cabinet, and therefore having the passageway along a side of the cabinet reduces the temperature of the base and/or top, thereby reducing the likelihood of a user encountering an uncomfortable temperature.

Any flow redirection means on the cabinet will also be located along the side of the cabinet, rather than across the top and/base of the cabinet, and this allows the contents of the cabinet to be seen more easily when looking towards the front of the cabinet as well as removed more easily.

The passageway may be a first passageway, the airflow may be a first airflow; and wherein a second of the opposed sides may define a second passageway extending to the front of the cabinet, wherein a fan is configured to circulate a second airflow through the second passageway, wherein the first airflow opposes the second airflow so as to create opposing air curtains across the front of the cabinet.

By providing opposing air curtains, a turbulent meeting point is created across the front of the cabinet. The turbulent airflow accelerates thermal mixing and heat convention, so as to provide a more uniform temperature throughout the interior space. This helps to avoid “dead points” within the interior space that may otherwise be underheated or overheated.

The opposing air curtains may meet in a middle of the opening. This helps to evenly distribute the turbulence within the interior space.

An end of the passageway or passageways adjacent the front of the cabinet may have a reduced aperture in comparison to an aperture of the passageway or passageways upstream. This increases the speed of the airflow, as well as concentrating it on a smaller target area. This reduced divergence of the flow helps to increase turbulence as the airflow meets an opposing airflow or meets a side of the cabinet, as well as improving the air curtain and thereby increasing thermal insulation across the boundary between outside and the interior space in the cabinet.

The open fronted food storage cabinet may comprise a flow redirection means at an end of passageway or passageways. This helps to streamline the air curtain, and direct it in the most effective direction. Thus, the air curtain is more effective at increasing thermal insulation across the boundary between outside and the interior space in the cabinet.

The fan may be located adjacent the rear side of the cabinet. This prevents the fan from blocking the view of the consumer through the front or one of the sides of the cabinet, whilst also providing a convenient location for creating circular flow.

The rear side of the cabinet may comprise a perforated wall adjacent the interior space that fluidically connects the interior space to the fan. This is one way in which air can be extracted from the interior space. This allows the flow to be fully circular, with air flowing from adjacent the front of the cabinet towards the rear of the cabinet.

The open fronted food storage cabinet may comprise a temperature control element configured to alter a temperature of the airflow in the passageway or passageways. In this way, the temperature in the cabinet can be controlled to maintain the contents of the cabinet at a specific temperature.

The fan may be located at a first end of the passageway(s), and the temperature control element located towards a second end of the passageway so as to be spaced from the fan. Temperature control elements can create significant heat, but by spacing the fan from the temperature control element the fan can be prevented from overheating.

The temperature control element may be a cooler element configured to decrease a temperature of the airflow in the passageway or passageways. The temperature control element may be a heater element configured to increase a temperature of the airflow in the passageway or passageways.

The top, rear, base and opposed sides may be first top, rear, base and opposed sides. The interior space may be a first interior space of the cabinet, and the opening may be a first opening. And the cabinet may comprise a second top, rear, base and opposed sides defining a second interior space of the cabinet which is accessible through a second opening to the front of the cabinet defined between edges of the second top, base and opposing sides of the cabinet; wherein a first of the second opposed sides define a passageway extending to the front of the cabinet.

The passageways in the opposed sides of adjacent interior spaces prevent the top and base from being directly heated. In particular, if a passageway extended through the top of a lower cabinet section, the base of an upper cabinet section may heat up and thereby heat the contents of the contents in the upper cabinet section by conduction. By having the passageways in the opposing side(s) of the cabinet, heat transfer is primarily by convection.

The passageway of the first of the opposed sides may be a first passageway, and wherein the first of the second opposed sides defines a third passageway separated from the first passageway by the first top and the second base or separated from the first passageway by the first base and the second top.

This allows separate airflows to enter each interior space. The airflows can be separately tailored in terms of any number of parameters, including temperature, speed, pressure, and turbulence. This thereby allows the conditions in the interior spaces to be separately controlled.

An air gap may be provided between the first top and the second base or between the first base and the second top. This improves the thermal insulation between the first and second interior spaces.

The open fronted food storage cabinet may comprise a first temperature control element configured to alter a temperature of the airflow in the first passageway and a second temperature control element configured to alter a temperature of the airflow in the third passageway.

This allows each interior space to be held at a different temperature. This is particularly advantageous in combination with the side passages, as there is less thermal transfer between the two interior spaces, thereby allowing their temperatures to be held more easily and at greater disparities.

A temperature in the first interior space may be different to a temperature in the second interior space. This allows different consumer products, that require different temperature, to be held in adjacent interior spaces.

It will be appreciated that the features of the first, second and third aspects may readily be combined, as will be apparent from the following description.

### BRIEF DESCRIPTION OF THE DRAWINGS

Embodiments of the invention will now be described with reference to the accompanying drawings, in which:

FIG. 1 shows a perspective view of a front of a cabinet according to an aspect of the invention;

FIG. 2 shows a schematic representation of the flow within an interior space within the cabinet;

FIG. 3 shows a perspective view of a rear of the cabinet;

FIG. 4 shows a perspective view of the cabinet showing a representation of the airflow in upper and lower sections of the cabinet;

FIG. 5 shows a rear perspective view of the cabinet in which an assembly is removed;

FIG. 6 shows an exploded view of the assembly of FIG. 5.

### DETAILED DESCRIPTION OF EMBODIMENT(S)

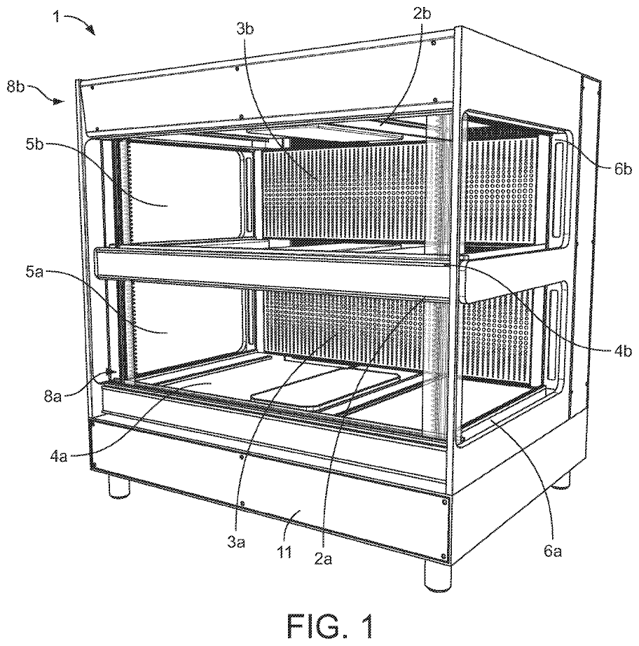

FIG. 1 shows a perspective view of an open fronted cabinet 1. The cabinet includes a first interior space defined by a first top 2a, rear 3a, base 4a, and opposed sides 5a, 6a. The first interior space is accessible through an opening to the front of the cabinet 1 defined between edges of the first top 2a, rear 3a, base 4a, and opposed sides 5a, 6a of the cabinet 1.

The interior space of the cabinet 1 defines a space within which food items can be placed for subsequent selection and retrieval by a consumer. In particular, the base 4a may function as a shelf on which the food items are placed. The consumer can reach into the interior space through the opening in order make and retrieve the selected food item.

The cabinet 1 may be modular, or otherwise constructed, so as to include multiple sections 8a, 8b. For instance, a lower section 8a that includes the first interior space and an upper section 8b including a second interior space.

FIG. 1 shows the cabinet 1 including a second interior space defined by a second top 2b, rear 3b, base 4b, and opposed sides 5b, 6b. The second interior space is accessible through a second opening to the front of the cabinet 1 defined between edges of the second top 2b, rear 3b, base 4b, and opposed sides 5b, 6b of the cabinet 1.

The cabinet 1 is arranged such that each interior space is adjacent to another interior space. In the example shown in FIG. 1, the first top 2a, rear 3a, base 4a, and opposed sides 5a, 6a define a first cabinet section 8a that is below the second top 2b, rear 3b, base 4b, and opposed sides 5b, 6b that define a second cabinet section 8b.

In this case, the top 2a of the first cabinet section 8a may form at least part of the base 4b of the second cabinet section 8b. Alternatively, the top 2a of the first cabinet section 8a may be separated from the base 4b of the second cabinet section 8b, for example separated by an air gap to improve insulation between the interior spaces.

The cabinet sections 8a, 8b may rest upon a chassis 11. The chassis 1 may house various components of the cabinet 1, such as a controller (not shown), that control various features of the cabinet. For example, the fan 9, temperature control element 15, display 31 and camera 32 that are discussed in the examples below may each be controlled by a controller.

In the following, the first, lower, section 8a of the cabinet 1 will be described, although it will be appreciated that other sections 8a, 8b of the cabinet 1, such as the upper section 8b, may be the same or substantially similar.

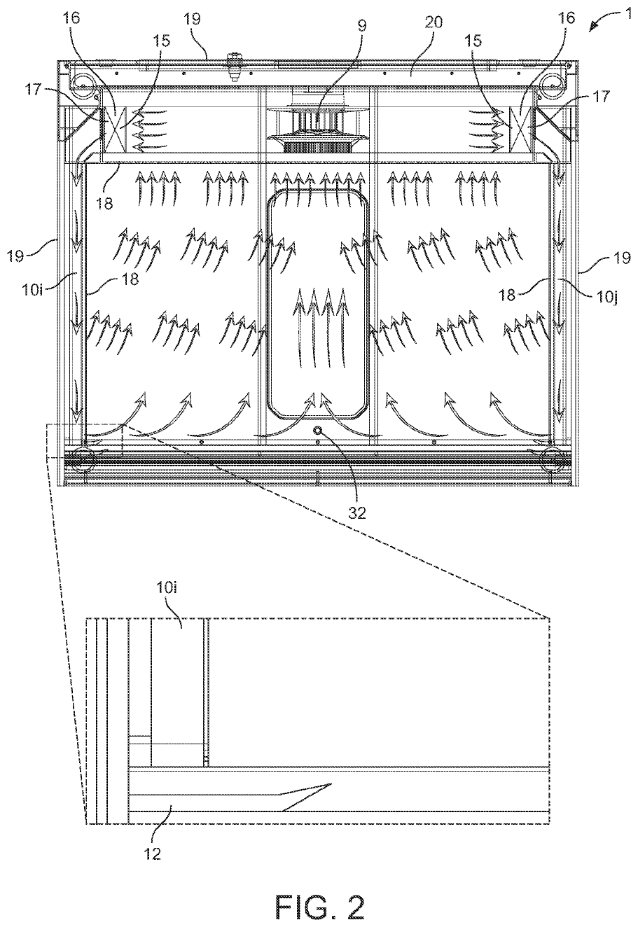

The rear side 3a may include one or more of an inner panel 18 and an outer panel 19 (See FIG. 2). Similarly, each of the opposed sides 5a, 6b may include inner and outer panels 18, 19.

The cabinet 1 may include one or more fans 9 configured to flow air into one or more of the interior spaces of the cabinet 1. The fans 9 may be controlled by a DC motor, or other means, so that the speed and/or volume of air exiting the fan 9 can be controlled. This allows the air flow to be controlled, for example so that the system can respond to internal temperature or temperature variations within the interior space or environmental factors such as external temperature or wind. The fans 9 may be located in any suitable position on the cabinet 1, although the fans 9 are preferably located adjacent a rear side 3a of the cabinet 1, i.e. between the inner and outer panels 18, 19 of the rear side 3a. This prevents the fan 9 from blocking the view of the consumer through the front of the cabinet 1, or one of the sides 2a, 4a, 5a, 6a, whilst also providing a convenient location for creating circular flow.

The fan 9 may be any suitable fan, or combination of fans, such as an axial fan, centrifugal fan, or cross flow fan.

Each fan 9 may be located in a passageway 10i, 10j extending from the fan 9 to the front of the cabinet 1. FIG. 2 shows a first passageway 10i and a second passageway 10j each extending along one of the opposed sides 5a, 6a of the cabinet 1.

The passageways 10i, 10j extend to the front of the cabinet 1 so as to direct and air flow, via the fan 9, across the front of the cabinet 1, and in particular across the front of the interior space. This creates opposing air curtains that help to prevent heat transfer between the interior space and the air outside the cabinet 1, whilst allowing convenient access to the interior space without the need for a door on the front of the cabinet 1.

As the air curtains are opposing, they meet at a location across the front of the cabinet 1 so as to create a turbulent flow inside the interior space of the cabinet 1. The turbulent airflow increases thermal mixing and heat convention, and this provides a more uniform temperature throughout the interior space. This helps to avoid “dead points” within the interior space that may otherwise be underheated or overheated.

In the example shown in FIG. 2, the air curtains meet in a middle of the opening of the cabinet 1. However, it will be appreciated that the air curtains may meet at any position across the front of the cabinet 1 so as to create the desired conditions in the interior space. For example, the position at which the opposing air curtains meet may be tailored to create differential turbulence or temperature in parts of the interior space.

Whilst it is preferable for the passageways 10i, 10j to extend along the opposing sides 5a, 6b of the cabinet 1, such as shown in FIG. 2, it will be appreciated that the opposing air curtains may be formed by passageways 10i, 10j that extend along the top 2a and base 4a of the cabinet 1.

It is preferable to avoid hot spots on the contents of the cabinet 1 (e.g. food items), and it is therefore preferable to provide heat transfer to the food item by convection rather than conduction. By providing a passageway 10i, 10j that extends through a side 5a, 6a of the cabinet 1, rather than the top 2a and/or base 4a, the air flow through the passageway 10i, 10j substantially does not directly heat the top 2a and/or base 4a of the cabinet 1 and therefore heat transfer is primarily via convection through the air rather than conduction.

An added benefit of reducing heat transfer to the top 2a and base 4a is that these are the parts of the cabinet 1 most likely to be touched, and therefore this design reduces the likelihood of a user encountering an uncomfortable temperature.

Further advantages of having passageways 10i, 10j in the sides 5a, 6a of the cabinet 1, rather than the top 2a and base 4a, include the repositioning of any flow redirection means 12 (See the detailed view in FIG. 2). A flow redirection means 12 may be positioned at the end of each passageway 10i, 10j to improve the aerodynamics of the flow as it travels across the front of the cabinet 1 and into the respective interior space.

The consumer is most likely to be positioned directly in front of the cabinet 1, and potentially looking up or down on the contents depending on their height. By positioning the flow redirection means 12 at the sides 5a, 6a of the cabinet 1, the contents of the cabinet 1 can be seen more easily through the top 2a or base 4a.

The passageways 10i, 10j may have any suitable dimensions, for instance each passageway 10i, 10j may have a reduced aperture at the end adjacent the front of the cabinet 1 so as to increase the air speed as the air exits the passageway 10i, 10j and to concentrate the air flow to more effectively create the air curtain.

It will be appreciated that many of these benefits can be achieved with a single air flow through a single passageway 10i, 10j along one of the sides 5a, 6a of the cabinet 1. For instance, direct heating or the top 2a and base 4a is avoided, whilst any flow redirection means 12 is also moved away from the top 2a or base 4a.

It will be appreciated that whilst each fan 9 may create air flow through a single passageway 10i, 10j, in alternative examples a single fan 9 may create air flow in two passageways 10i, 10j, such as shown in FIG. 2. The fans 9 are preferably located adjacent the rear side 3a of the cabinet 1 so as to position them in a location that does not obstruct the view of a consumer. A fan 9 at the rear 3a of the cabinet 1 is also well placed to create a circular air flow that ensures an even temperature distribution throughout the interior space. To create this circular flow, air travels along the passage way 10i, 10j, through the interior space, and through the rear 3a of the cabinet.

The example shown in FIG. 1 includes a perforated rear side 3a of the cabinet 1 through which the fan 9 is able to draw air towards it. The holes in the perforated rear side 3a may be regulated so as to average out the air extraction rates over the whole of the rear side 3a. For instance, the holes may be larger towards the opposing sides 5a, 6a than towards the middle of the rear side 3a. This can help to more evenly distribute the air flow within the interior space.

The passageways 10i, 10j may include an associated temperature control element 15 configured to alter a temperature of the airflow in the passageway 10i, 10j.

The temperature control element 15 may be a cooler element 16 configured to decrease a temperature of the airflow in the passageway 10i, 10j. For example, the cooler element 16 may include a refrigerant, a thermoelectric cooler or any other suitable cooling means known in the art.

The temperature control element 15 may be a heater element 17 configured to increase a temperature of the airflow in the passageway 10i, 10j. For example, the heater element 17 may include a coil heater, band heater, circulation heater or any other suitable heater element known in the art.

The fan 9 is preferably centrally located at the rear side 3a of the cabinet 1, as this is typically the best position to create a circular airflow that reaches throughout the interior space. However, it will be appreciated that the fan 9 may be located off-centre.

The fan 9 may be located at a first end of the passageway 10i, 10j. The temperature control element 15 may be a heater element 17 that develops significant heat, such that it is preferable the fan 9 is spaced from the heater element 17 to mitigate overheating of the fan 9. Similarly, the fan 9 may generate at least some heat such that it is preferable to space the temperature control element 15 from the fan 9 when the temperature control element 15 is a cooler element 16.

The spacing between the temperature control element 15 may be any suitable distance, for example at least 10%, 20% or 30% of the length of the passageway 10i, 10j.

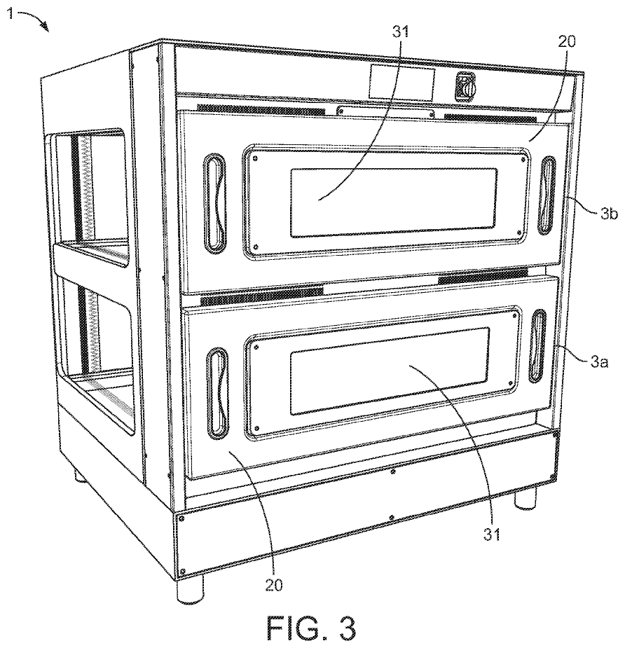

The cabinet 1 may include one or more assemblies 20 that may house the fan 9, temperature control element 15 and/or allow access to the interior space through one of the sides 3a, 5a, 6a. FIG. 3 shows the assemblies 20 located on the rear 3a, 3b of each interior space, although it will be appreciated the cassettes 20 may be otherwise located on the cabinet 1. In examples in which the fans 9 are located in an assembly 20, the passageways 10i, 10j will extend at least partially through the assembly 20 (For example as shown in FIG. 2).

Each interior space may have an associated assembly 20, such as shown in FIG. 3, however it will be appreciated that a single assembly 20 may provide access to multiple interior spaces. In this latter example, a single passageway 10i, 10j may extend to the front of both interior spaces.

Preferably, the air flow to each interior space flows through a respective passageway 10i, 10j. In this case, the passageways 10i, 10j may be separated from one another by the top 2a of a lower cabinet section 8a and/or the base 4b of an upper cabinet section 8b. With this arrangement, it is easier to construct a modular cabinet 1 to which additional sections 8a, 8b can be added.

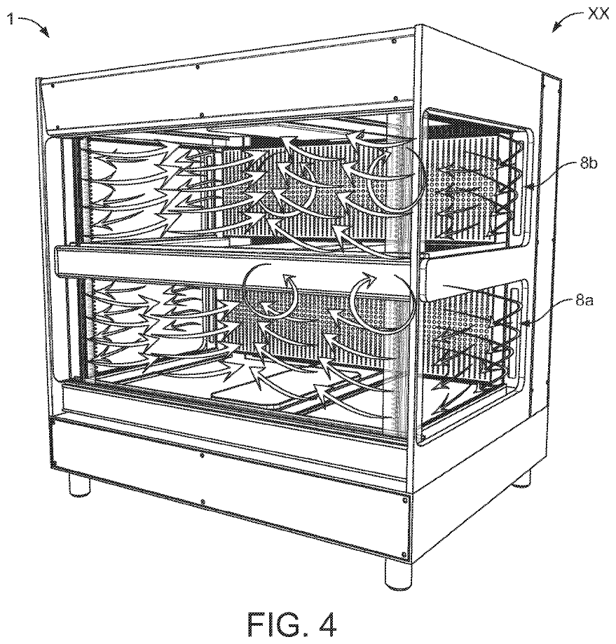

In the case of having separate passages 10i, 10j, separate air flows through each passageway 10i, 10j are provided, such as shown in FIG. 4. This allows each air flow to be tailored in terms of its temperature, air speed, air pressure, turbulence, or any other characteristics. This can allow adjacent interior spaces to be controlled differently, for example at different temperatures.

The passages 10i, 10j of the first and second sections 8a, 8b of the cabinet 1 may each have an associated temperature control element 15. In this manner, the temperature in the first interior space may be different to the temperature in the second interior space. For instance, the first interior space may be held at a temperature above room temperature, whilst the second interior space may be held at a temperature below room temperature Alternatively, both the first and second interior spaces may be held at differing elevated temperatures above room temperature.

It will be appreciated that thermal transfer between adjacent sections 8a, 8b of the cabinet 1 is reduced in examples in which the passages 10i, 10j are positioned in the opposing sides 5a, 5b, 6a, 6b of the sections 8a, 8b, compared to examples in which the passages 10i, 10j extend along the top 2a, 2b and/or base 4a, 4b of each section 8a, 8b. This is due to the reduced surface area of the passageway 10i, 10j that is adjacent the interior space of the other cabinet section 8a, 8b.

As detailed above, the cabinet 1 is arranged to display consumer items (such as food) that are viewed, selected and can be removed by the consumer through the open front. The stock of consumer items in the cabinet 1 therefore need to be periodically replenished.

It can be convenient to refill the contents of the cabinet 1 from the rear side 3a, 3b of each section 8a, 8b, as this makes it convenient when putting new food items at the back of the cabinet such that the existing food items remain at the front of the cabinet 1 where they will be selected first. The assembly 20 may provide such access.

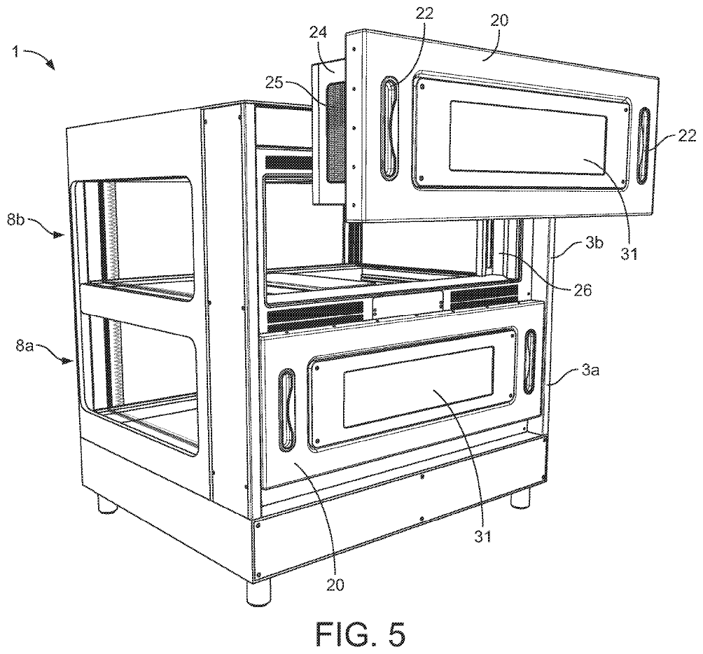

As such, the assembly 20 may be detachable from the rear side 3a, 3b of the cabinet 1, for example as shown in FIG. 5, so as to provide access to the interior space.

Alternatively, or in addition, the assembly 20 may be pivotably coupled to the rear side 3a, 3b of the cabinet 1. The assembly 20 may be pivotably coupled to the rear side 3a, 3b on any of its edges, such as the upper edge so as to be rotated upwardly upon accessing the interior space.

The assembly 20 may include one or more handles 22 for a user to grip the assembly 20. The handles 22 may assist the user in moving the assembly 20 so as to allow access to the interior space behind it. FIG. 5 shows the assembly 20 including two handles 22 although it will be appreciated the assembly 20 may include any suitable number of handles 22.

As shown in FIG. 2, the assembly 20 may house the fan(s) 9 and temperature control elements 15. In this case, the assembly 20 may be removed for easier repair of the fan(s) 9 and/or temperature control element 15. For example, the assembly 20 may be moved to a more convenient location for repair to be performed, and/or the entire cassette 20 may be replaced to quickly return the cabinet 1 to full operation.

To facilitate smooth air flow through the passageways 10i, 10j, whilst preventing direct contact with the temperature control elements 15 or fan(s) 9 inside the assembly 20, the ends 24 of the assembly 20 may include a perforated section 25 that allows air flow therethrough whilst preventing direct contact to the temperature control element 15 and fan 9.

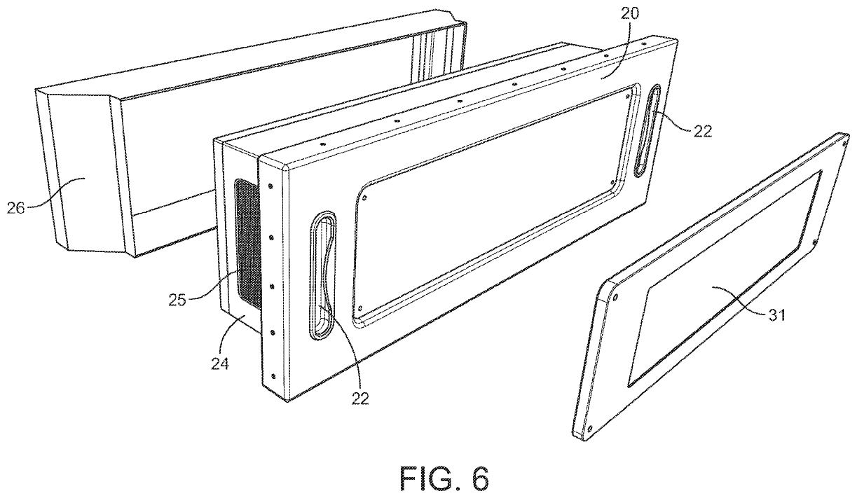

The redirection of the air flow, from the assembly 20 and through the opposing sides 5a, 6a of the cabinet 1, may be improved by a duct arrangement 26, such as shown in FIG. 6. The duct arrangement 26 is located between the perforated section 25 of the assembly 20 and one or both of the sides 5a, 6a so as to direct air flow therebetween.

Open fronted food storage cabinets of the prior art typically rely on a visual inspection through the open front, or through transparent sides of the cabinet, in order to, e.g., view the contents of the cabinet, view stock levels, and decide upon any restocking required. However, this requires the observer to reposition themselves in a more convenient position that allows all food items to be seen. This can be burdensome.

In order to overcome at least some of these difficulties, the cabinet 1 may include a display 31 communicatively coupled to a camera 32 (the camera 32 identified in FIG. 2). The display 31 may be any suitable display, such as an LCD display. The camera may be any suitable camera, such as a visible light camera or infrared light camera.

The display 31 is configured to receive a signal from the camera 32 so as to show an image captured by the camera 32. The signal may be conveyed from the camera 32 to the display 31 via a wired or wireless connection. The wireless connection may for example be a Bluetooth or wireless internet connection. In particular, the camera 32 is configured to capture an image of an interior space of the cabinet 1. Preferably there is an associated display and camera 32 with each interior space, such that each camera 32 captures an image of a single interior space and outputs the signal to a specific display 31, however it will be appreciated that any arrangements of camera 32 and display 31 may be provided. For instance, the camera 32 may send a signal to multiple displays 31, or multiple cameras 32 may send a signal to a single display 31.

In some examples, such as shown in FIGS. 3 and 5, there may be a display 31 associated with each cabinet section 8a, 8b, with a separate camera 32 communicatively connected to each respective display 31 so as to show an image of the respective interior space on said display 31. This provides a better view of the respective interior spaces, ensures the camera 32 need not be placed outside the interior spaces as it doesn't need to be positioned so as to view multiple interior spaces concurrently, and helps prevent confusion in regards to the interior space to be replenished with stock as each display will be associated with a specific interior space. In addition, a camera 32 to view each interior space also helps to maintain a modular design of the cabinet 1, such that additional cabinet sections 8a, 8b can be added that each have an associated display 31 and camera.

The camera 32 may capture discrete images at set time intervals, so as to allow periodic monitoring of the interior space (e.g. one image per hour). In order to provide a live-feed of the interior space, and thereby monitor stocks more often, the camera 32 may be configured to capture a plurality of images so as to display a video on the display 31.

The camera 32 is preferably located within the interior space of the cabinet 1, as opposed to outside the interior space. This protects the camera 32 from the external environment, and from incidental damage that might be caused by users if the camera 32 were mounted so as to stick out from the cabinet 1.

The camera 32 may be located towards a front of the cabinet 1. This can provide a good view of the food items towards the front of the cabinet 1, which are the food items that the consumer will see first. Whereas a view of only the rear of the cabinet may falsely suggest the stock to be fully on display, despite gaps in stock being present towards the front of the cabinet 1.

The camera 32 may be positioned adjacent the top 2a of the interior space. This allows a birds-eye view of the interior space, and allows a greater proportion of the food items adjacent the base 4a to be viewed by the camera 32.

The camera 32 may point towards the rear side 3a of the cabinet 1. In this manner, the display 31 will show a view of the interior space from the perspective of the consumer. This allows stock levels and display quality to be checked from the perspective of the consumer.

The camera 32 may comprise a wide-angle lens, such as a fisheye lens. A wide-angle lens allows a larger proportion of the interior space to be captured by the camera 32 and displayed on the display 31. This may allow a single camera 32 to view the entire interior space of a larger cabinet 1 than would otherwise be possible. The camera 32 may also be positioned closer to the food items in the interior space whilst still allowing the whole contents of the interior space to be viewed.

The display 31 may be an interactive display comprising means for interaction, for example a button/buttons or touchscreen that allows the image presented by the display 31 to be changed. For instance, allowing the view from a particular camera 32 to selected for viewing, or enlarged in comparison to other views from cameras, or to add/edit information presented on the display 31.

In some examples, the display 31 may be positioned on one of the sides 3a, 5a, 6a. In further examples, the display 31 may be separate from the cabinet 1. For example, the display 31 may be remotely connected to the camera 32 so as to allow the stock to be viewed in a stock room, kitchen, office or other location. The cabinet 1 may be configured such that the camera 32 sends a signal to a display 31 on the cabinet 1 and to a further display 31 provided at a location remote from the cabinet 1.

The display 31 may form part of the assembly 20, such as shown in FIGS. 3, 5 & 6. This provides a convenient position for the display 31 that prevents the display 31 interrupting the view of consumers, whilst also providing a convenient location for retailers to view the interior space without interrupting the view of consumers. Furthermore, when the assembly 20 is moved to access the interior space, the display 31 will also move with it.

However, it will be appreciated that the display 31 may be positioned in any suitable position.

The assembly 20 can allow the fan 9, temperature control element 15, and display 31 to be co-located on the assembly 20 and thereby concentrate all of these items towards the rear of the cabinet 1 where the consumers view will be less impacted, whilst providing a convenient means for moving these items so as to better access the interior space through the rear side 3a.

The display 31 may be detachable from the assembly 20 and/or cabinet 1. In this way, the display 31 may (for example) be primarily attached to the cabinet 1, whilst providing means of moving the display 31 to a new location when required, temporarily or otherwise. For example, this may allow the display 31 to be taken to a stock room so that the contents of the cabinet 1 can be reviewed whilst selecting new food items. In this example, the display 31 could be removed from the cabinet 1 whilst preserving the remaining functions of the cabinet 1 at full capacity (e.g. the air flow and temperature control).

A detachable display 31 also provides a means for easy replacement and/or repair. For example, the display 31 may be moved to a more convenient location for repair to be performed, and/or the display 31 may be replaced to quickly return the cabinet 1 to full operation.

The cabinet 1 may be constructed of any suitable materials, and is preferably substantially transparent. For example, the top 2a, 2b rear 3a, 3b, base 4a, 4b, and opposed sides 5a, 5b, 6a, 6b may each be formed at least partly of transparent materials such as transparent plastic or glass.

It will be appreciated that the various features of the cabinet 1 may be further utilised for various activities. For example, the image signals from the camera 32 may be monitored to determine interactions, log interactions, monitor activity levels across a period of time, identify patterns in consumer behaviour, and/or automatically monitor stock levels so as to indicate when restocking is required. The operation of the fan and temperature control element may also be monitored and/or controlled externally, or be used to feed-back information regarding projected and real-time conditions within the cabinet.

Although the invention has been described above with reference to one or more preferred embodiments, it will be appreciated that various changes or modifications may be made without departing from the scope of the invention as defined in the appended claims.

1-18. (canceled)

19. A doorless open fronted heated food storage cabinet comprising:
a top, rear, base and opposed sides, the top, rear, base and opposing sides defining an interior space of the cabinet which is accessible through an opening to the front of the cabinet defined between edges of the top, base and opposed sides of the cabinet, wherein a first of the opposed sides define a passageway extending to the front of the cabinet,
a fan in the passageway configured to circulate an airflow through the passageway so as to create an air curtain across the front of the cabinet,
wherein the passageway is a first passageway, the airflow is a first airflow; and
wherein a second of the opposed sides defines a second passageway extending to the front of the cabinet, wherein the fan is configured to circulate a second airflow through the second passageway,
wherein the first airflow opposes the second airflow so as to create opposing air curtains across the front of the cabinet, and
wherein the first airflow extends horizontally across the front of the cabinet in a first direction, and the second airflow extends horizonally across the front of the cabinet in a second direction opposite to the first direction.

20. The open fronted food storage cabinet of claim 19, wherein the opposing air curtains meet in a middle of the opening.

21. The open fronted food storage cabinet of claim 19, wherein an end of the passageway(s) adjacent the front of the cabinet has a reduced aperture in comparison to an aperture of the passageway(s) upstream.

22. The open fronted food storage cabinet of claim 19, comprising a flow redirection means at an end of the passageway(s).

23. The open fronted food storage cabinet of claim 19, wherein the fan is located adjacent the rear side of the cabinet.

24. The open fronted food storage cabinet of claim 19, wherein the rear side of the cabinet comprises a perforated wall adjacent the interior space that fluidically connects the interior space to the fan.

25. The open fronted food storage cabinet of claim 19, comprising a temperature control element configured to alter a temperature of the airflow in the passageway(s).

26. The open fronted food storage cabinet of claim 25, wherein the fan is located at a first end of the passageway(s), and the temperature control element is located towards a second end of the passageway so as to be spaced from the fan.

27. The open fronted food storage cabinet of one of claim 25, wherein the temperature control element is a heater element configured to increase a temperature of the airflow in the passageway(s).

28. The open fronted food storage cabinet of claim 19,
wherein the top, rear, base and opposed sides are first top, rear, base and opposed sides, the interior space is a first interior space of the cabinet, and the opening is a first opening;
the cabinet comprising a second top, rear, base and opposed sides defining a second interior space of the cabinet which is accessible through a second opening to the front of the cabinet defined between edges of the second top, base and opposing sides of the cabinet;
wherein a first of the second opposed sides define a passageway extending to the front of the cabinet.

29. The open fronted food storage cabinet of claim 28, wherein the passageway of the first of the opposed sides is a first passageway, and wherein the first of the second opposed sides defines a third passageway separated from the first passageway by the first top and the second base or separated from the first passageway by the first base and the second top

30. The open fronted food storage cabinet of claim 29, wherein an air gap is provided between the first top and the second base or between the first base and the second top.

31. The open fronted food storage cabinet of claim 29, comprising a first temperature control element configured to alter a temperature of the airflow in the first passageway and a second temperature control element configured to alter a temperature of the airflow in the third passageway.

32. The open fronted food storage cabinet of claim 27, wherein a temperature in the first interior space is different to a temperature in the second interior space.
